(19) United States
(12) Patent Application Publication
(10) Pub. No.: US 2012/0029138 A1
(43) Pub. Date: Feb. 2, 2012

(54) Anti-settling composition and methods for use

(75) Inventors: Nemesio Martinez-Castro, Bristol, PA (US); Herve Adam, Clarksburg, NJ (US); Lichang Zhou, Lawrenceville, NJ (US); Jose Ruiz, Burlington, NJ (US); Pierre Hennaux, New York, NY (US)

(73) Assignee: RHODIA OPERATIONS, Cranbury, NJ (US)

(21) Appl. No.: 13/136,478

(22) Filed: Aug. 2, 2011

Related U.S. Application Data
(60) Provisional application No. 61/400,779, filed on Aug. 2, 2010.

(51) Int. Cl. C09D 147/00; C08F 36/20

(52) U.S. Cl. 524/518; 526/282; 524/554

(57) ABSTRACT

An anti-settling additive, compositions containing anti-settling additives and methods for use, the additive containing a monomer or polymer compound that contains at least one polymerizable functional group per molecule, and at least one bicycloheptyl-, bicycloheptenyl-, or branched (C₅-C₄₂)alkyl-polyether radical per molecule, wherein the bicycloheptyl- or bicycloheptenyl-polyether radical may optionally be substituted on one or more of the ring carbon atoms by one or two (C₁-C₆)alkyl groups per ring carbon atom is useful in making polymers.

### CROSS REFERENCE TO RELATED APPLICATIONS

This application claims the benefit of U.S. Provisional Application Ser. No. 61/400,779, filed Aug. 2, 2010, herein incorporated by reference.

### FIELD OF INVENTION

The present invention relates to anti-settling compounds and additives for coating and aqueous systems and, in particular, to anti-settling additives for use in coating compositions/formulations and the like.

### DESCRIPTION OF RELATED ART

Anti-settling agents are used in the coatings industry to prevent pigments or other finely divided solid particles from settling during storage. Anti-settling agents can be categorized as organic clay, polyamide, ethylene vinyl acetate polymers, fumed silica and calcium sulfonate derivatives. Many of these anti-settling agents, however, have their drawbacks. For example, organic clay and fumed silica can negatively impact the coatings in which they are applied through gloss decrease and increase of viscosity of the paint, significantly affecting flow and leveling of the paint.

Anti-settling agents in a coating formulation requires additives which generally maintain the proper viscosity of the coating formulation. This is sometimes difficult, as, for example, better control pigment dispersion or settling means generally higher viscosities. Coating compositions with extremely high viscosities just after application may negatively affect flow rates where, as a consequence, low flow rates occur and hinder the formation of a smooth film.

Conventional natural and synthetic polymers have limitations with respect to use as thickeners in aqueous systems, particularly in paints and coating compositions. In general, they do not provide a rheological profile suitable for the desired flow and other properties required in paints and coatings. For example, HEC swells rapidly in water and forms lumps, which are not readily dispersible. A correct balance of properties must be achieved among the various additives.

### SUMMARY OF THE INVENTION

The present invention relates to novel monomers and polymers comprising such monomers for use as anti-settling additives, compositions incorporating such anti-settling additives, as well as methods for use. Described herein are additives which control pigment, as well as other fine solids, suspension in coating and aqueous compositions. It has been surprisingly discovered that the additives as described herein provide stability while adding no or little viscosity to the aqueous system or coating. It is desirable in many cases for such additives not to impart additional viscosity or to impart very little viscosity to the aqueous systems or coating.

In one embodiment, adding pigment suspension agents or particle suspension agents (also hereinafter collectively referred to as “anti-settling additives” or “anti-settling agents”) to coating compositions help to prevent pigments or other finely divided solid particles from settling during storage. Depending on the hardness of the settling, it is difficult, and sometimes not possible, to evenly re-disperse the pigment and other particles by stirring the solid material throughout the aqueous composition or coating composition.

Typically, few pigments are dispersed to their ultimate particle size, and coatings and aqueous compositions can contain many aggregates and flocculants; however, the anti-settling additives described herein maintain pigment dispersion levels at an adequate level for extended periods, allowing coating and aqueous compositions containing pigments and fine solid particles to be stored for long periods. In some particular embodiments, the coating composition is a stain, varnish or lacquer.

In one aspect, paints and coatings with improved anti-settling properties can be achieved by incorporating into the aqueous composition or coating composition a polymer comprising one or more monomeric units, each comprising at least one bicycloheptyl-, bicycloheptenyl- or branched (C₅-C₄₂)alkyl-polyether radical per molecule, wherein the bicycloheptyl- or bicycloheptenyl-polyether radical may optionally be substituted on one or more of the ring carbon atoms by one or two (C₁-C₆) alkyl groups per ring carbon atom. Without being bound by theory, it is believed that the improved settling property is due to the soft glassy behavior of the polymer and monomer of the present invention.

In another aspect, described herein are anti-settling additives comprising a polymer, the polymer comprising at least one monomer that comprises:

i) at least one polymerizable functional group per molecule; and

ii) at least one polyether radical per molecule according to structure (I):

—R¹³—R¹²—R¹¹ (I)

wherein:

R¹¹ is bicycloheptyl, bicycloheptenyl, or linear or branched (C₅-C₄₂) alkyl wherein the bicycloheptyl- or bicycloheptenyl-polyether radical may optionally be substituted on one or more of the ring carbon atoms by one or two (C₁-C₆)alkyl groups per ring carbon atom,

R¹² is absent or is a bivalent linking group, and

R¹³ is according to structure (VIII):

OC_{p′}H_{2p′}ᵣOC_{q}H_{2q}ₛₜ (VIII)

wherein:
p′ and q are independently integers of from 2 to 5,
each r is independently an integer of from 1 to about 80,
each s is independently an integer of from 1 to about 80, and

t is an integer of from 1 to 50,

wherein the polymer is characterized by a weight average molecular weight of less than about 500,000 and is used as an anti-settling agent in low viscosity coating compositions and coating applications.

In another embodiment, t is an integer of from 1 to 50, provided that the product of t multiplied times the sum of r+s is less than or equal to about 100

R¹¹, in another embodiment, is hydrogen, a linear or branched C₁-C₅₀ alkyl group, cycloalkyl group, hydroxyalkyl group, alkoxyalkyl group, alkenyl group, alkoxyl agroup, aryl group, aralkyl group, alkaryl group, or alkylalkoxy group, cycloalkyl group, that may be optionally substituted, a linear or branched C₁-C₅₀ hydroxyl or alkoxyl groups (including but not limited to ethoxylated, propoxylated, ethopropoxylated), a carbon containing ring which is saturated or unsaturated and which is optionally substituted, an optionally aromatic, saturated or unsaturated carbonaceous ring, or is bicycloheptyl, bicycloheptenyl, or linear or branched (C₅-C₄₂) alkyl wherein the bicycloheptyl- or bicycloheptenyl-polyether radical may optionally be substituted on one or more of the ring carbon atoms by one or two (C₁-C₆)alkyl groups per ring carbon atom

In some embodiments, R¹¹ contains from about 1 to about 75 carbon atoms, in other embodiments R¹¹ contains from about 2 to about 50 carbon atoms, in another embodiment, R¹¹ contains from about 3 to about 35 carbon atoms, in a further embodiment, R¹¹ contains from about 4 to about 35 carbon atoms.

In another aspect, described herein is a monomer compound comprising:

at least one polymerizable functional group per molecule, and at least one bicycloheptyl-, bicycloheptenyl-, or branched (C₅-C₄₂)alkyl-polyether radical per molecule, wherein the bicycloheptyl- or bicycloheptenyl-polyether radical may optionally be substituted on one or more of the ring carbon atoms by one or two (C₁-C₆)alkyl groups per carbon atom.

In yet another aspect, described herein are anti-settling compositions comprising at least one anti-settling additive comprising at least a polymer that, based on the total weight of monomers, comprises:
(a) from about 25 to about 70 percent by weight acid monomeric units, each independently comprising a carboxylic acid-functional substituent group,
(b) from about 30 to about 70 percent by weight nonionic monomeric units, each independently comprising a nonionic substituent group, and
(c) from about 0.05 to about 25 percent by weight hydrophobic monomeric units, each independently comprising at least one bicycloheptyl-, bicycloheptenyl-, or branched (C₅-C₄₂)alkyl-polyether radical per monomeric unit, wherein the bicycloheptyl- or bicycloheptenyl-polyether radical may optionally be substituted on one or more of the ring carbon atoms by one or two (C₁-C₆)alkyl groups per carbon atom.

In a further aspect, described herein are methods for inhibiting the settling of solid particles or pigment particles in an aqueous or coating composition by adding in such composition an anti-settling additive, which comprises a polymer. The polymer comprises one or more monomeric units, each comprising at least one bicycloheptyl-, bicycloheptenyl- or branched (C₅-C₄₂)alkyl-polyether radical per molecule, wherein the bicycloheptyl- or bicycloheptenyl-polyether radical may optionally be substituted on one or more of the ring carbon atoms by one or two (C₁-C₆)alkyl groups per ring carbon atom, the polymer capable of imparting anti-settling properties to an aqueous compositions or in coating compositions.

In another aspect, described herein are methods for inhibiting the settling of solid particles in an aqueous composition or coating composition, the method comprising the steps of:

adding an anti-settling additive to an aqueous composition, the anti-settling additive including at least one polymer that, based on the total weight of monomers, comprises:
(a) from about 25 to about 70 percent by weight acid monomeric units, each independently comprising a carboxylic acid-functional substituent group,
(b) from about 30 to about 70 percent by weight nonionic monomeric units, each independently comprising a nonionic substituent group, and
(c) from about 0.05 to about 25 percent by weight hydrophobic monomeric units, each independently comprising at least one bicycloheptyl-, bicycloheptenyl-, or branched (C₅-C₄₂) alkyl-polyether radical per monomeric unit, wherein the bicycloheptyl- or bicycloheptenyl-polyether radical may optionally be substituted on one or more of the ring carbon atoms by one or two (C₁-C₆) alkyl groups per carbon atom.

In one embodiment, an aqueous composition or coating composition is a low viscosity coating having a KU range of less than about 200 KU, less than about 100 KU, less than about 80 KU, less than about 75, less than about 60 KU, or less than about 50 KU (in certain embodiments).

In one embodiment, the anti-settling additive is added in an amount from about 0.5 wt % to about 1 wt % based on the total weight of the aqueous composition. In another embodiment, the anti-settling additive is added in an amount from about 0.1 wt % to about 20 wt %, or in other embodiments from about 0.2 wt % to about 10 wt %, based on the total weight of the aqueous composition. In yet another embodiment, the anti-settling additive is added in an amount from about 0.4 wt % to about 5 wt % based on the total weight of the aqueous composition.

In yet another aspect, described herein are methods for inhibiting the settling of solid particles in an aqueous or coating composition, the method comprising the steps of:

adding an anti-settling additive or anti-settling composition to an aqueous composition or coating composition, the anti-settling additive including at least a polymer that, based on the total weight of monomers, comprises:
(a) about 25 to about 70 weight percent based on total monomers of at least one C₃-C₈ alpha beta-ethylenically unsaturated carboxylic acid monomer of the structure (II):

RCH═C(R′)COOH (II)
wherein R is H, CH₃, or —CH₂COOX; and wherein if R is H, then R′ is H, C₁-C₄ alkyl, or —CH₂COOX; if R is —C(O)OX, then R′ is H or —CH₂C(O)OX; or if R is CH₃, then R′ is H; and X, if present, is H or C₁-C₄ alkyl;
(b) about 30 to about 70 weight percent based on total monomers of at least one copolymerizable non-ionic C₂-C₁₂ alpha beta-ethylenically unsaturated monomer of the structure (III):

H₂C═CYZ (III)
wherein Y is H, CH₃, or Cl; Z is CN, Cl, —COOR′, —C₈H₄R′, —COOR″, or —HC═CH₂; and wherein R is C₁-C₈ alkyl or C₂-C₈ hydroxy alkyl; and wherein R′ is H, Cl, Br, or C₁-C₄ alkyl; and R″ is C₁-C₈ alkyl; and
(c) about 0.05 to about 25 weight percent based on total monomer weight of at least one ethylenically unsaturated monomer represented by the structure selected from a group consisting of structure III and structure V; wherein structure III represents an ester of an alkoxylated fatty alcohol, according to structure (IV)

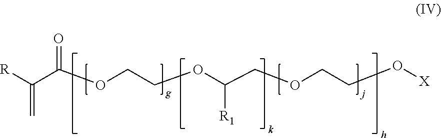

wherein R is H or CH₃; wherein R₁ is a —(CH₂)ₚH alkyl chain;
wherein p is an integer from 1 to about 4; wherein j is an integer from 0 to about 50; wherein k is an integer from 0 to about 20;
wherein g is an integer from 0 to about 50; wherein g+j is greater or equal to 1; wherein h is and integer from 1 to 4; and wherein X is according to the following structure (Vi) or structure (Vii):

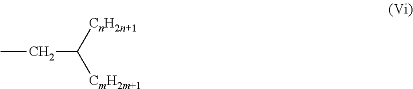

wherein m and n are, independently, are positive integers from 1 to 39 and m+n represents an integer from 4 to 40; or

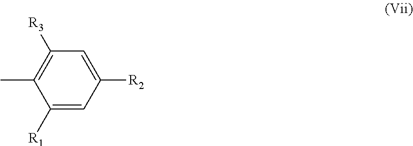

wherein R1, R2 and R3 are independently selected from: —H, tert-butyl, butyl, isobutyl,

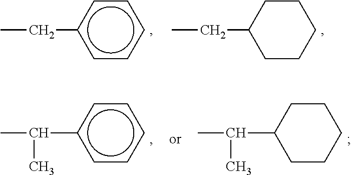

wherein structure V is an ester of an alkoxylated nopol according to structure (VI)

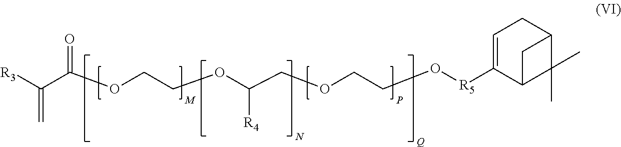

wherein R₃ is H or CH₃; R₄ is an alkyl chain containing 1 to about 4 carbons; R₅ is an alkyl chain containing 1 to about 6 carbons (typically 2 carbons); M is an integer from 0 to about 50; N is and integer from 0 to 20, or an integer of less than or equal to M or N; P is an integer from 0 to about 50; wherein P+M is greater or equal to 1; wherein Q is an integer from 1 to 4.

The anti-settling additives described herein are useful for stabilizing an aqueous or coating composition, in particular, for improving pigment suspension properties, without significantly increasing the viscosity in the aqueous composition or coating composition.

The anti-settling additives described herein are utilized to provide a homogeneous, pourable liquid which improves pigment suspension properties in coatings without a significant increase in viscosity. In addition to the improved properties mentioned, the anti-settling agent described herein needs only very low or minimal shear in order to incorporate it into a formulation, coating composition or aqueous composition, whereas other additives are difficult to incorporate in the formulation. In one embodiment, the minimal shear required is about 200 rpm (rotations per minute) or greater. In another embodiment, the minimal shear required is about 300 rpm (rotations per minute) or greater. In yet another embodiment, the minimal shear required is about 400 rpm (rotations per minute) or greater. In yet a further embodiment, the minimal shear required is about 500 rpm (rotations per minute) or greater.

### DETAILED DESCRIPTION OF THE INVENTION

As used herein, the terminology “(Cᵣ-Cₛ)” in reference to an organic group, wherein r and s are each integers, indicates that the group may contain from r carbon atoms to s carbon atoms per group.

As used herein, the term “alkyl” means a monovalent straight or branched saturated hydrocarbon radical, more typically, a monovalent straight or branched saturated (which, in one particular embodiment, is C₁-C₇₅) hydrocarbon radical, such as, for example, methyl, ethyl, n-propyl, isopropyl, n-butyl, isobutyl, tert-butyl, n-hexyl, n-octyl, and n-hexadecyl.

As used herein, “anti-settling additive” means an additive, as described herein for example, that is useful for preventing excessive flocculation (of pigments, solid or fine particles in an aqueous or coating composition) during storage and/or handling.

As used herein, the term “hydroxyalkyl” means an alkyl radical, more typically an alkyl radical (which, in one particular embodiment, is C₁-C₇₅), that is substituted with one or more hydroxyl groups, such as, for example, hydroxyethyl, hydroxypropyl.

As used herein, the term “aryl” means an unsaturated hydrocarbon radical that contains one or more six-membered carbon rings, more typically a single six-membered carbon ring, in which the unsaturation may be represented by three conjugated carbon-carbon double bonds, which may be substituted one or more of the ring carbons with hydrocarbon, typically alkyl or alkenyl, halo, or haloalkyl groups, such as, for example, phenyl, methylphenyl, trimethylphenyl, chlorophenyl, trichloromethylphenyl.

As used herein, the term “halo” means chloro, bromo, iodo, or fluoro.

As used herein, the term “haloalkyl means an alkyl radical (which, in one particular embodiment, is C₁-C₇₅), more typically an alkyl radical, that is substituted on one or more carbon atoms with one or more halo groups, such as, for example, chloromethyl, trichloromethyl.

As used herein, the term “cycloalkyl” means a saturated or unsaturated (which, in one particular embodiment, is C₁-C₇₅) hydrocarbon radical that includes one or more cyclic alkyl rings, such as, for example, cyclopentyl, cycloheptyl, cyclooctyl, and “bicyloalkyl” means a cycloalkyl ring system that comprises two condensed rings, such as bicycloheptyl.

As used herein, the term “alkenyl” means an unsaturated straight or branched hydrocarbon radical, more typically an unsaturated straight, branched, (which, in one particular embodiment, is C₁-C₇₅) hydrocarbon radical, that contains one or more carbon-carbon double bonds, such as, for example, ethenyl, n-propenyl, iso-propenyl,

As used herein, the term “cycloalkenyl” means an unsaturated (which, in one particular embodiment, is C₁-C₇₅) hydrocarbon radical, which contains one or more cyclic alkenyl rings, such as cyclohexenyl, cycloheptenyl, and “bicycloalkenyl” means a cycloalkenyl ring system that comprises two condensed rings, such as bicycloheptenyl.

The “bicyclo[d.e.f]” notation is used herein in reference to bicycloheptyl and bicycloheptenyl ring systems in accordance with the von Baeyer system for naming polycyclic compounds, wherein a bicyclic system is named by the prefix “bicyclo-” to indicate number of rings in the system, followed by a series of three Arabic numbers, listed in descending numerical order, separated by full stops, and enclosed in square brackets, to indicate the respective number of skeletal atoms in each acyclic chain connecting the two common atoms (the “bridgehead atoms”), excluding the bridgehead atoms.

The polymer used in the present method may be a homopolymer or a copolymer. Suitable polymers include linear polymers, branched polymers, star polymers, and comb polymers. Suitable copolymers include random copolymers, alternating copolymers, block copolymers, and graft copolymers.

As used herein, each of the terms “monomer”, “polymer”, “homopolymer”, “copolymer”, “linear polymer”, “branched polymer”, “star polymer”, “comb polymer”, “random copolymer”, alternating copolymer”, “block copolymer”, “graft copolymer”, has the meaning ascribed to it in Glossary of basic terms in polymer science (IUPAC Recommendations 1996), Pure Appl. Chem., Vol. 68, No. 12, pp. 2287-2311, 1996.

In the present specification, the term “molecular weight” of the polymer or anti-settling additive refers to the weight average molecular weight measured using gas permeation chromatography.

Suitable polymerizable functional groups include, for example, acrylo, methacrylo, acrylamido, methacrylamido, diallylamino, allyl ether, vinyl ether, α-alkenyl, maleimido, styrenyl, and α-alkyl styrenyl groups.

In one embodiment, the bicycloheptyl- or bicycloheptenyl- or branched (C₅-C₄₂)alkyl-polyether radical is according to structure (I):

—R¹³—R¹²—R¹¹ (I)

wherein:
R¹¹ is bicycloheptyl, bicycloheptenyl, or branched (C₅-C₄₂)alkyl, wherein the bicycloheptyl or bicycloheptenyl group may optionally be substituted on one or more of the ring carbon atoms by one or two (C₁-C₆)alkyl groups per ring carbon atom,
R¹² is absent, or is a bivalent linking group, and
R¹³ is a bivalent polyether group.

In one embodiment, R¹¹ is a branched alkyl group according to structure (VII):

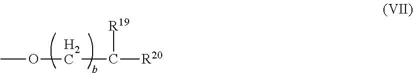

wherein:
R¹⁹ and R²⁰ are each independently (C₁-C₄₀)alkyl, and
b is an integer of from 0 to 39, provided that R¹¹, that is, R¹⁹, R²⁰ and the —(CH₂)_{b}— radical taken together, comprises a total of from about 6 to about 42, more typically about 12 to about 42, carbon atoms.

In one embodiment, R¹¹ is bicyclo[d.e.f]heptyl or bicyclo[d.e.f]heptenyl, wherein d is 2, 3, or 4, e is 1 or 2, f is 0 or 1, and the sum of d+e+f=5, and which may, optionally, be substituted on one or more of the ring carbon atoms by one or more (C₁-C₆)alkyl groups. More typically, R¹¹ is:
(i) a bicyclo[3.1.1]heptyl or bicyclo[3.1.1]heptenyl group that is bonded to R¹², if present, or to R¹³, if R¹² is not present, via its carbon atom at the 2-position and is typically substituted on its carbon atom at the 6-position by one or two (C₁-C₆)alkyl radicals, more typically by two methyl radicals, or
(ii) a bicyclo[3.1.1]heptyl or bicyclo[2.2.1]heptenyl group that is bonded to R¹², if present, or to R¹³, if R¹² is not present, via its carbon atom at the 2-position or 3-position and is typically substituted on its carbon atom at the 7 position by one or two (C₁-C₆)alkyl radicals, more typically by two methyl radicals.

In one embodiment, R¹² is a bivalent alkylene, oxyalkylene or oxyalkylene oxy radical which may optionally be substituted on one or more carbon atoms of the radical with alkenyl, cycloalkyl, or cycloalkenyl. In one embodiment, R¹² is —CᵥH₂ᵥ—, wherein v is an integer of from 1 to 10, more typically from 1 to 6, even more typically from 2 to 4. In one embodiment, R¹² is −OCᵥH₂ᵥ—, wherein v is an integer of from 1 to 10, more typically from 1 to 6, even more typically from 2 to 4. In one embodiment, R¹² is

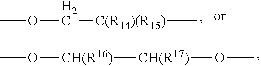

or —O—CH(R¹⁶)—CH(R¹⁷)—O—, wherein R¹⁴, R¹⁵, R¹⁶, and R¹⁷ are each independently H, alkyl, alkenyl, cycloalkyl or cycloalkenyl, more typically H, (C₁-C₆)alkyl, or (C₁-C₆)alkenyl, and even more typically H, methyl, or ethyl.

In one embodiment, R¹³ is a bivalent polyoxyalkylene group according to structure (VIII):

OC_{p′}H_{2p′}ᵣOC_{q}H_{2q}ₛₜ (VIII)

wherein:
p′ and q are independently integers of from 2 to 5, more typically 2 or 3,
each r is independently an integer of from 0 to about 80, more typically from 1 to about 50,
each s is independently an integer of from 0 to about 80, more typically from about 1 to about 50, and
t is an integer of from 1 to 50, provided that the product of t multiplied times the sum of r+s is less than or equal to about 100.

In embodiments wherein —(OC_{p′}H_{2p′})— and (—(OC_{q}H_{2q})—, oxyalkylene units with p′ not equal to q, are each present, the respective oxylakylene units may be arranged randomly, in blocks, or in alternating order.

In one embodiment, the monomer of the present invention is according to structure (IX):

R¹⁸—R¹³—R¹²—R¹¹ (IX)

wherein:

R¹¹, R¹², and R¹³ are each defined as above, and

R¹⁸ is acrylo, methacrylo, acrylamido, methacrylamido, diallylamino, allyl ether, vinyl ether, α-alkenyl, maleimido, styrenyl, or α-alkyl styrenyl.

In one embodiment, R¹⁸ is acrylo or methacrylo.

In one embodiment, the monomer is a compound according to structure (X):

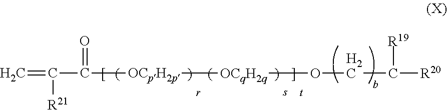

wherein R²¹ is H or methyl, and R¹⁹, R²⁰, b, p′, q, r, s, and t are each as described above.

In one embodiment, the monomer is a compound according to structure (XI):

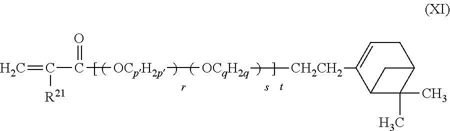

wherein R²¹ is H or methyl, and p′, q, r, s, and t are each as described above.

In one embodiment, the monomer is a compound according to structure (XI.a)

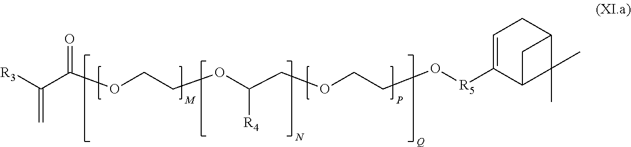

wherein R₃ is H or CH₃; R₄ is an alkyl chain containing 1 to about 4 carbons (in one embodiment R₄ is an alkyl chain containing 1 to about 2 carbons); R₅ is an alkyl chain containing 1 to about 6 carbon atoms (in some embodiments, R₅ is an alkyl chain containing from 1 to about 3 carbon atoms, or R₅ is an alkyl chain containing 2 carbon atoms); M is an integer from 0 to about 50 (in some embodiments, M is an integer from 0 to about 30, or M is an integer from 1 to about 25); N is and integer from 0 to 20, or an integer of less than or equal to M or N; P is an integer from 0 to about 50 (in some embodiments, P is an integer from 0 to about 30, or P is an integer from 1 to about 25); wherein P+M is greater or equal to 1; wherein Q is an integer from 1 to 4.

In another embodiment, the polymer comprises at least one monomer comprising:

i) at least one polymerizable functional group per molecule; and

ii) at least one polyether radical per molecule according to structure (I):

—R¹³—R¹²—R¹¹ (I)

wherein:

R¹¹ is bicycloheptyl, bicycloheptenyl, linear or branched (C₅-C₄₂) alkyl wherein the bicycloheptyl- or bicycloheptenyl-polyether radical may optionally be substituted on one or more of the ring carbon atoms by one or two (C₁-C₆)alkyl groups per ring carbon atom,

R¹² is absent or is a bivalent linking group, and

R¹³ is according to structure (VIII):

OC_{p′}H_{2p′}ᵣOC_{q}H_{2q}ₛₜ (VIII)

wherein:
p′ and q are independently integers of from 2 to 5,
each r is independently an integer of from 1 to about 80,
each s is independently an integer of from 1 to about 80, and

t is an integer of from 1 to 50 (in one embodiment, optionally, the product of t multiplied times the sum of r+s is less than or equal to about 100),

wherein the polymer is characterized by a weight average molecular weight of less than about 500,000 and is used as an anti-settling agent in low viscosity coating compositions or coating applications.

In other embodiments, R¹¹ is hydrogen, a linear or branched C₁-C₅₀ alkyl group, cycloalkyl group, hydroxyalkyl group, alkoxyalkyl group, haloalkyl, alkenyl group, alkoxyl agroup, aryl group, aralkyl group, alkaryl group, or alkylalkoxy group, cycloalkenyl group, which may be optionally substituted.

R¹¹, in yet another embodiment, is a carbon containing ring which is saturated or unsaturated and which is optionally substituted, or an optionally aromatic, saturated or unsaturated carbonaceous ring.

In one embodiment, the anti-settling additive has a weight average molecular weight of from about 1,000 g/mol to about 2,000,000 g/mol. In another embodiment, the polymer or anti-settling additive has a weight average molecular weight of from about 10,000 g/mol to about 1,000,000 g/mol.

In another embodiment, the low molecular weight polymer or anti-settling additive has a weight average molecular weight of less than about 1,000,000 g/mol. In another embodiment, the polymer or anti-settling additive has a weight average molecular weight of less than about 750,000 g/mol. In a further embodiment, the polymer or anti-settling additive has a weight average molecular weight of less than about 600,000 g/mol. In yet a further embodiment, the polymer or anti-settling additive has a weight average molecular weight of less than about 500,000 g/mol, or in another embodiment, less than about 400,000 g/mol or in another embodiment, less than about 300,000 g/mol. In yet another embodiment, the polymer or anti-settling additive has a weight average molecular weight of less than about 150,000 g/mol. In a further embodiment, the polymer or anti-settling additive has a weight average molecular weight of less than about 100,000 g/mol. In yet a further embodiment, the polymer or anti-settling additive has a weight average molecular weight of less than about 80,000 g/mol.

Typically, in one embodiment, the polymer or anti-settling additive has a weight average molecular weight of less than about 250,000 g/mol, more typically less than about 200,000 g/mol.

Suitable bicycloheptyl- and bicycloheptenyl-moieties may be derived from, for example, terpenic compounds having core (non-substituted) 7 carbon atom bicyclic ring systems according to structures (XII)-(XVII):

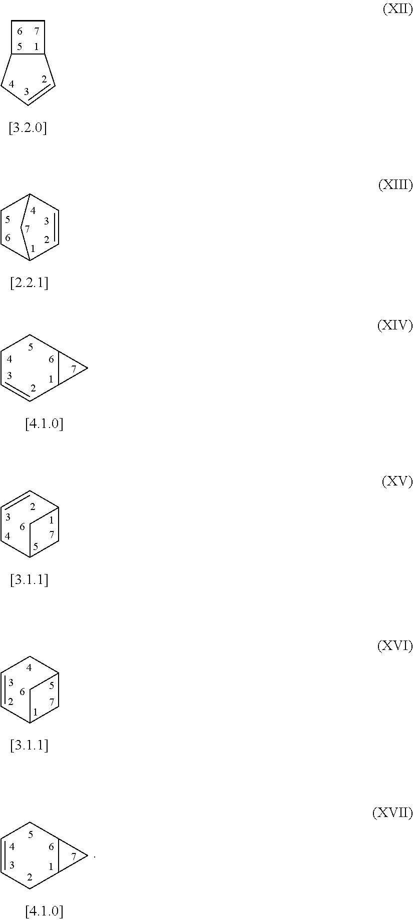

For example, a bicycloheptenyl intermediate compound (XVIII), known as “Nobol”:

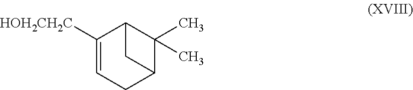

is made by reacting β-pinene with formaldehyde, and
a bicycloheptyl intermediate compound (XIX), known as “Arbanol:

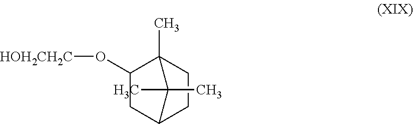

is made by isomerization of α-pinene to camphene and ethoxyhydroxylation of the camphene.

In one embodiment, a bicycloheptyl- or bicycloheptenyl-intermediate is alkoxylated by reacting the bicycloheptyl- or bicycloheptenyl intermediate with one or more alkylene oxide compounds, such as ethylene oxide or propylene oxide, to form a bicycloheptyl-, or bicycloheptenyl-polyether intermediate. The alkoxylation may be conducted according to well known methods, typically at a temperature in the range of about 100° to about 250° C. and at a pressure in the range of from about 1 to about 4 bars, in the presence of a catalyst, such as a strong base, an aliphatic amine, or a Lewis acid, and an inert gas, such as nitrogen or argon.

The bicycloheptyl-, or bicycloheptenyl-polyether monomer is then formed by addition of a polymerizable functional group to the bicycloheptyl- or bicycloheptenyl-polyether intermediate, by, for example, esterification, under suitable reaction conditions, of the bicycloheptyl- or bicycloheptenyl-polyether intermediate with, for example, methacrylic anhydride.

Alternatively, a monomer comprising a polymerizable functional group, such as for example, polyethylene glycol monomethacrylate, can be alkoxylated to form a polyether monomer and the alkoxylated monomer then reacted with the bicycloheptyl- or bicycloheptenyl-intermediate to form the bicycloheptyl-, or bicycloheptenyl-polyether monomer.

In one embodiment, the polymer as described herein comprises from about 30 to about 65, more typically from about 30 to about 60, percent by weight acid monomeric units, from about 35 to about 70, more typically from about 40 to about 60, percent by weight nonionic monomeric units, and from about 0.5 to about 35, typically from about 0.5 to about 25, typically from about 0.5 to about 20, typically from about 2 to about 10, percent by weight hydrophobic monomeric units.

In one embodiment, the acid monomer units of the polymer as described herein are derived from one or more ethylenically unsaturated carboxylic acid monomer, such as, for example, methacrylic acid.

In one embodiment, the nonionic monomer units of the polymer described herein are derived from one or more ethylenically unsaturated nonionic monomer, such as an alkyl or hydroxyalkyl ester of an acid monomer, for example, 2-ethylhexylacrylate.

In one embodiment, the hydrophobic monomeric units of the polymer as described herein each comprise a pendant substituent group according to structure (I), wherein R¹¹, R¹², and R¹³ are each as described above.

In one embodiment, the polymer as described herein is prepared from the following components: (A) about 25 to 70 weight percent based on total monomers of a C₃-C₈ alpha beta-ethylenically unsaturated carboxylic acid monomer; (B) about 30 to 70 weight percent based on total monomers of at least one copolymerizable non-ionic C₂-C₁₂ alpha beta-ethylenically unsaturated monomer, and (C) about 0.05 to about 25 weight percent based on total monomer weight of a selected hydrophobic ethylenically unsaturated monomer. The proportions of the individual monomers can be varied to achieve optimum properties for specific applications. In one embodiment, component (C) is from about 0.05 to about 16 weight percent based on total monomer weight of a selected hydrophobic ethylenically unsaturated monomer. In another embodiment, component (C) is from about 1 to about 10 weight percent based on total monomer weight of a selected hydrophobic ethylenically unsaturated monomer.

Component A is at least one C₃-C₈ alpha beta-ethylenically unsaturated carboxylic acid monomer of the structure (II):

RCH═C(R′)COOH (II)

wherein if R is H, then R′ is H, C₁-C₄ alkyl, or —CH₂COOX; if R is —C(O)OX, then R′ is H or —CH₂C(O)OX; or if R is CH₃, then R′ is H; and X, if present, is H or C₁-C₄ alkyl.

Carboxylic acids useful as an ethylenically unsaturated carboxylic acid monomer and as component (A) include itaconic acid, fumaric acid, crotonic acid, acrylic acid, methacrylic acid, and maleic acid. Typically, the carboxylic acid monomer is methacrylic acid or a mixture thereof with one or more other carboxylic acids. Half esters are also suitable.

In some embodiments, Component A is present at about 20 to 85, about 25 to 70, typically about 30 to about 65, or about 35 to about 60 weight percent based on total monomer weight of components A, B, and C.

Component B is at least one copolymerizable non-ionic C₂-C₁₂ alpha beta-ethylenically unsaturated monomer of the structure (III):

H₂C═CYZ (III)

wherein Y is H, CH₃, or Cl; Z is CN, Cl, —COOR′, —C₆H₄R′, —COOR, or —HC═CH₂; R is C₁-C₈ alkyl or C₂-C₈ hydroxy alkyl; R′ is H, Cl, Br, or C₁-C₄ alkyl, and is C₁-C₈ alkyl.

Monomers useful as the ethylenically unsaturated nonionic monomer and as component B include, but are not limited to, C₁-C₈ alkyl and C₂-C₈ hydroxyalkyl esters of acrylic and methacrylic acid. Useful monomers include ethyl acrylate, ethyl methacrylate, methyl methacrylate, 2-ethylhexyl acrylate, butyl acrylate, butyl methacrylate, 2-hydroxyethyl acrylate, 2-hydroxybutyl methacrylate, styrene, vinyltoluene, t-butylstyrene, isopropylstyrene, and p-chlorostyrene, vinyl acetate, vinyl butyrate, vinyl caprolate; acrylonitrile, methacrylonitrile, butadiene, isoprene, vinyl chloride, vinylidene chloride, and combinations thereof. A typical monomer is ethyl acrylate alone or in combination with styrene, hydroxyethyl acrylate, acrylonitrile, vinyl chloride or vinyl acetate.

Component B is present at from about 20 to about 95, about 30 to about 70, typically about 35 to about 70, and from about 40 to about 60 weight percent based on total monomer weight of components A, B, and C. Typically, the hydrophilic balance of the polymer product can be adjusted by the appropriate selection of the unsaturated nonionic monomer.

In one embodiment, Component C is at least one hydrophobic ethylenically unsaturated monomer selected from among those represented in Structure (I)

—R¹³—R¹²—R¹¹ (I)

wherein:

R¹¹ is hydrogen, a linear or branched C₁-C₅₀ alkyl group, cycloalkyl group, hydroxyalkyl group, alkoxyalkyl group, haloalkyl, alkenyl group, alkoxyl agroup, aryl group, aralkyl group, alkaryl group, or alkylalkoxy group, cycloalkenyl group, that may be optionally substituted, or is bicycloheptyl, bicycloheptenyl, linear (C₅-C₄₂) alkyl or branched (C₅-C₄₂) alkyl, wherein the bicycloheptyl- or bicycloheptenyl-polyether radical may optionally be substituted on one or more of the ring carbon atoms by one or two (C₁-C₆)alkyl groups per ring carbon atom,

R¹² is absent or is a bivalent linking group, and

R¹³ is according to structure (VIII):

OC_{p′}H_{2p′}ᵣOC_{q}H_{2q}ₛₜ (VIII)

wherein:
p′ and q are independently integers of from 2 to 5,
each r is independently an integer of from 1 to about 80,
each s is independently an integer of from 1 to about 80, and

t is an integer of from 1 to 50 (one embodiment, optionally, the product of t multiplied times the sum of r+s is less than or equal to about 100).

In one embodiment, Component C is at least one hydrophobic ethylenically unsaturated monomer selected from among those represented in structure (IV) or structure (VI). Structure (IV) has the following structure:

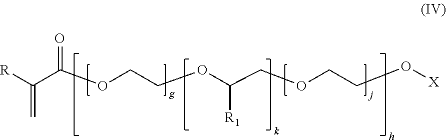

wherein R is H or CH₃; wherein R₁ is a —(CH₂)ₚH alkyl chain;

wherein p is an integer from 1 to about 4; wherein j is an integer from 0 to about 50; wherein k is an integer from 0 to about 20; wherein g is an integer from 0 to about 50; wherein g+j is greater or equal to 1; wherein h is and integer from 1 to 4; and wherein X is according to the following structure (Vi) or structure (Vii):

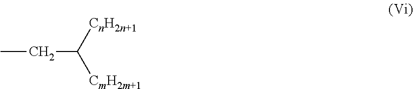

wherein m and n are independently positive integers, and m+n represent an integer from 4 to 40 and typically 4 to 20. In a typical structure, k is equal to 0, 1 equal to is 25, h is equal to 1, n is equal to 8, and m is equal to 10; or

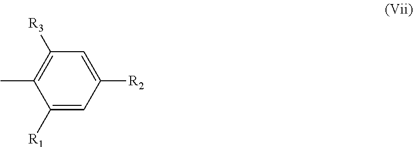

wherein R1, R2 and R3 are independently selected from:

—H, tert-butyl, butyl, isobutyl,

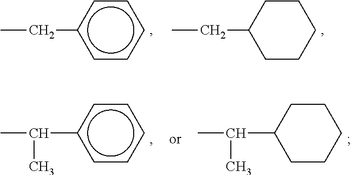

Branched esters corresponding to component B are typically synthesized from Guerbet alcohols. These alcohols have a branched structure and exhibit oxidative stability at elevated temperatures.

Structure (VI) has the following structure:

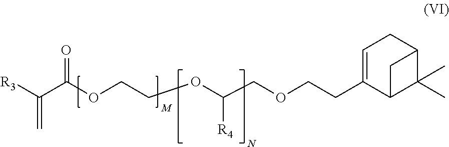

wherein R₃ is H or CH₃; R₄ is an alkyl chain containing 1 to about 4 carbons; M is an integer from 1 to about 50 and typically about 10 to about 40; and N is an integer having a value of 0 or an integer less than or equal to M. In a most typical structure, R₃ and R₄ are CH₃, M is equal to 25 and N is equal to 5.

In yet another embodiment, Component C is at least one hydrophobic ethylenically unsaturated monomer according to Structure (XI.a):

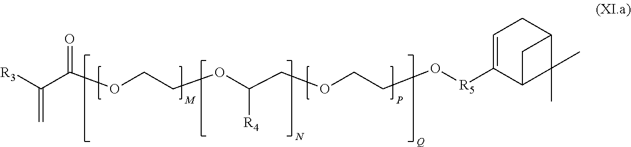

wherein R₃ is H or CH₃; R₄ is an alkyl chain containing 1 to about 4 carbon atoms; R₅ is an alkyl chain containing 1 to about 6 carbon atoms; M is an integer from 0 to about 50; N is and integer from 0 to 20, or an integer of less than or equal to M or N; P is an integer from 0 to about 50; wherein P+M is greater or equal to 1; wherein Q is an integer from 1 to 4.

Component C, in another embodiment, is present at about 0.05 to about 20, typically about 1 to about 15, and most typically about 2 to about 10 weight percent based on total monomer weight of components A, B, and C.

In one embodiment, the polymer composition has a solids content of up to about 60 wt % and, more typically about 20 to about 50 wt %, based on the combined weight of the polymer as described herein (including components A, B, and C) and emulsifiers/surfactants employed.

In one embodiment, the polymer composition is in the form of an aqueous colloidal polymer dispersion. When the polymer composition is in the form of an aqueous colloidal polymer dispersion, the composition is maintained at a pH of about 5 or less to maintain stability. More typically, the aqueous colloidal polymer dispersion composition has a pH of less than about 4. In one embodiment, the aqueous colloidal polymer dispersion contains between amount 0.1 to 90 wt % polymer as described herein. In another embodiment, the aqueous colloidal polymer dispersion comprises greater than 10 wt % polymer as described herein. In another embodiment, the aqueous colloidal polymer dispersion comprises greater than 30 wt % polymer as described herein. In yet another embodiment, the aqueous colloidal polymer dispersion comprises greater than 40 wt % polymer as described herein. In a further embodiment, the aqueous colloidal polymer dispersion comprises greater than 50 wt % polymer as described herein.

The polymer and polymer composition can be prepared from the above-described monomers by conventional emulsion polymerization techniques at an acid pH of about 5.0 or less using free-radical producing initiators, usually in an amount from 0.01 percent to 3 percent based on the weight of the monomers. Polymerization at an acid pH of about 5.0 or less permits direct preparation of an aqueous colloidal dispersion having relatively high solids content without the problem of excessive viscosity.

The free-radical producing initiators typically are peroxy compounds or oxidizing agents. Useful peroxy compounds or oxidizing agents compounds include, but are limited to, inorganic persulfate compounds such as ammonium persulfate, potassium persulfate, sodium persulfate; peroxides such as hydrogen peroxide; organic hydroperoxides, for example, cumene hydroperoxide, and t-butyl hydroperoxide; organic peroxides, for example, benzoyl peroxide, acetyl peroxide, lauroyl peroxide, peracetic acid, and perbenzoic acid (sometimes activated by a water-soluble reducing agent such as ferrous compound or sodium bisulfite); and other free-radical producing materials or techniques such as 2,2′-azobisisobutyronitrile and high energy radiation sources.

Optionally, a chain transfer agent can be used. Representative chain transfer agents are dodecanethiol, carbon tetrachloride, bromoform; bromotrichloromethane; and long-chain alkyl mercaptans and thioesters, such as n-dodecyl mercaptan, t-dodecyl mercaptan, octyl mercaptan, tetradecyl mercaptan, hexadecyl mercaptan, butyl thioglycolate, isooctyl thioglycolate, and dodecyl thioglycolate. The chain transfer agents can be used in amounts up to about 10 parts per 100 parts of polymerizable monomers.

The composition optionally has one or more emulsifiers. Useful emulsifiers include anionic surfactants, nonionic surfactants, amphoteric surfactants, and zwitterionic surfactants. Typical surfactants are anionic surfactants. Examples of anionic emulsifiers are the alkali metal alkyl aryl sulfonates, the alkali metal alkyl sulfates and the sulfonated alkyl esters. Specific examples of these well-known emulsifiers are sodium dodecylbenzenesulfonate, sodium disecondary-butylnaphthalene sulfonate, sodium lauryl sulfate, disodium dodecyldiphenyl ether disulfonate, disodium n-octadecylsulfosuccinamate and sodium dioctylsulfosuccinate. Useful nonionic emulsifiers include, for example, common structures based on polyethylene oxide or oligosaccharides hydrophilic heads.

Optionally, other ingredients well known in the emulsion polymerization art may be included, such as chelating agents, buffering agents, inorganic salts and pH adjusting agents.

Usually the copolymerization is carried out at a temperature between about 60° C. and 90° C., but higher or lower temperatures may be used. The polymerization can be carried out batchwise, stepwise or continuously with batch and/or continuous addition of the monomers in a conventional manner.

The monomers can be copolymerized in such proportions, and the resulting emulsion polymers can be physically blended, to give products with the desired balance of properties for specific applications. For example, if a more viscous product is desired, the acid and surfactant monomer content can be increased. Greater flexibility and coalescence can be obtained with higher amounts of ethyl acrylate. Addition of styrene as a second nonionic vinyl monomer will increase to a higher pH the adjustment required to dissolve the emulsion in an aqueous coating composition. Minor quantities of a polyfunctional monomer, such as itaconic or fumaric acid to introduce a higher carboxylic acid content or limited crosslinking, provide further control of the solubility of the emulsion polymer after pH adjustment.

Thus, by varying the monomers and their proportions, emulsion polymers having optimum properties for particular applications can be designed. Particularly effective liquid emulsion polymer are obtained by copolymerization of about 40 to about 50 weight percent of methacrylic acid, about 35 to about 50 weight percent of ethyl acrylate, and about 0.05 to 20 weight percent of the ester according to structures (I) or (III) and/or (IV).

The polymer products as described herein can be prepared by emulsion polymerization at an acid pH are in the form of stable aqueous colloidal dispersions containing the polymer dispersed as discrete particles having average particle diameters of about 500 to about 3000 Å and typically about 1000 to about 1750 Å as measured by light scattering. Dispersions containing polymer particles smaller than about 500 Å are difficult to stabilize, while particles larger than about 3000 Å reduce the ease of dispersion in the aqueous products.

In one embodiment, the emulsion polymerization process comprises charging a kettle or reactor. An initial charge typically comprises water, one or more surfactants, and an oxidizing agent compound. The initial charge is allowed to equilibrate, after which an initiator solution is added to the reactor before or during the addition of monomer emulsion. The aqueous initiator solution is prepared by mixing water with one or more oxidizing agent compounds as described herein, typically ammonia persulfate. After thermal equilibrium, a monomer emulsion is added on a semi-continuous basis for several hours. Optionally, a chain transfer agent may be added before, during or after the addition of the monomer emulsion. A monomer emulsion typically comprises water, one or more emulsion surfactants and monomers as described herein, which are mixed at medium to high shear to form a stable emulsion. After complete addition of the monomer emulsion and initiator solution, the reactor is allowed to proceed for 20 minutes to 1 hr, after which time a chaser solution is added, typically an ascorbic acid solution. After the reaction is allowed to cool down the resulting polymer is filtered to remove coagulum formed during polymerization.

In another embodiment, the emulsion polymerization technique comprises charging a kettle or reactor, and then heating the kettle or reactor while purging with nitrogen. The nitrogen purge is maintained throughout the run. A monomer emulsion (ME) of DI water (deionized water), surfactant, methyl acrylic acid, ethyl acrylate, and nopol-containing monomer is added to the kettle, as well as an initiator solution (IS) of DI water and ammonium persulfate. The kettle is held for over approximately 3 hours at constant elevated temperature. The kettle is held for an additional 30 minutes while rinsing the additional funnel of IS and its tubing (disconnected from the batch) with water. (The tubing is then reconnected to the batch.) Part 1 of a chaser system/solution of tertbutyl peroxybenzoate is added to the kettle and IS additional funnel is filled with Part 2 of the chaser system/solution of isoascorbic acid and DI water. Part 2 is added over the course of 30 minutes. The kettle is held at constant elevated temperature for 30 minutes.

These emulsion polymers will normally have number average molecular weights of at least about 30,000 as determined by gel permeation chromatography. In one embodiment, the polymer as described herein exhibits a molecular weight of from about 30,000 to about 5,000,000, more typically from about 100,000 to about 2,000,000. The polymers that are water-soluble when neutralized, in some embodiments, have molecular weights within the range of about 200,000 to about 5,000,000 are typical. In terms of a standard Brookfield viscosity measured as a 1 percent aqueous solution in ammonium salt form at pH 9 and 25° C., a polymer with a viscosity of about 100 to about 1,000,000 cps, and typically about 100 to about 300,000 cps, is particularly desirable for many applications. The aqueous dispersions of the polymers contain about 10-50 weight percent of polymer solids and are of relatively low viscosity. They can be readily metered and blended with aqueous product systems.

In addition to emulsion polymerization, polymers according to the present invention can also be made using known solution polymerization techniques. The monomers can be dissolved in an appropriate solvent such as toluene, xylene, tetrahydrofuran, or mixtures thereof. Polymerization can be accomplished in the time and at the temperature necessary, e.g., 60° C. to 80° C. and about 2 to 24 hours. The product can be obtained through normal techniques, including solvent stripping.

The polymers and polymer compositions described herein are useful anti-settling additives for a wide variety of applications such as aqueous paints and coatings. Solution-polymerized polymers can be used in solvent systems or emulsified by known techniques for use in aqueous systems. Other uses include latexes and detergents. Useful compositions can typically have an aqueous carrier, a pigment, cosmetic active, a polymer, and/or optional adjuvants. Useful detergents and cleansers will typically have aqueous carrier, an emulsion polymer, and optional adjuvants.

Synthetic latexes take the form of aqueous dispersions/suspensions of particles of latex polymers. Synthetic latexes include aqueous colloidal dispersions of water-insoluble polymers prepared by emulsion polymerization of one or more ethylenically unsaturated monomers. Typical of such synthetic latexes are emulsion copolymers of monoethylenically unsaturated compounds, such as styrene, methyl methacrylate, acrylonitrile with a conjugated diolefin, such as butadiene or isoprene; copolymers of styrene, acrylic and methacrylic esters, copolymers of vinyl halide, vinylidene halide, vinyl acetate and the like. Many other ethylenically unsaturated monomers or combinations thereof can be emulsion polymerized to form synthetic latexes. Such latexes are commonly employed in paints (latex paints) and coating compositions. The composition as described herein may be added to latexes.

Mixtures or combinations of two or more additives may be used, if desired. Latex polymers used in coating compositions are typically film-forming at temperatures about 25° C. or less, either inherently or through the use of plasticizers. Coating compositions include water-based consumer and industrial paints; sizing, inks, adhesives, pressure-sensitive adhesives and other coatings for paper, paperboard, textiles; and the like. In one embodiment,

As mentioned herein, it has been surprisingly discovered that low Mw polymers as described herein promote anti-settling properties in coating compositions without substantially increasing the viscosity of the coating composition. Although this property is beneficial in high viscosity, medium viscosity and low viscosity paints and coating compositions, this property becomes more pronounced (and more beneficial) in low viscosity paints and coating compositions. This is desirable as many times coating compositions are formulated specifically to have low viscosity properties for ease of application, consistency of application, etc. For example, stains and varnishes are desired by many end-users and retailers to have low viscosity; this allows not only for ease of application but for consistency in the tone, shade and/or color across the substrate to which it is applied. Low viscosity coating compositions are typically, but are not limited to, stains, varnishes, low viscosity water-based paints, lacquers, and the like. In one embodiment, low viscosity as referenced in relation to coating compositions means a KU range of less than about 200 KU, typically less than 100 KU, more typically less than 80 KU. In one embodiment, low viscosity coating compositions have a KU range of less than about 75, less than about 60 KU, or less than about 50 KU in other embodiments. Generally, one could use thickening agents such as typical HASE (Hydrophobically modified Alkali-soluble Emulsions) polymers to suspend particles in a formulation. However, in certain situation where viscosity cannot be substantially increased, use of such HASE polymers is undesirable in such situation.

Thus, the anti-settling additives as described herein enable the storage properties of water-based coating compositions such as stains, lacquers and the like to be improved.

Latex paints and coating compositions may contain various adjuvants, such as pigments, fillers and extenders. Useful pigments include, but are not limited to, titanium dioxide, mica, and iron oxides. Useful fillers and extenders include, but are not limited to, barium sulfate, calcium carbonate, clays, talc, and silica. The compositions as described herein are compatible with most latex paint systems and provide anti-settling properties without substantially increasing viscosity. In one embodiment, “without substantially increasing viscosity” means without increasing the viscosity (KU) of the coating composition by more than 10 percent after the addition of the additive as measured relative to the coating composition prior to such addition. In another embodiment, “without substantially increasing viscosity” means without increasing the viscosity (KU) of the coating composition by more than 7 percent after the addition of the additive as measured relative to the coating composition prior to such addition. In one embodiment, “without substantially increasing viscosity” means without increasing the viscosity (KU) of the coating composition by more than 15 percent after the addition of the additive as measured relative to the coating composition prior to such addition.

The polymer compositions of the present invention may be added to aqueous product systems at a wide range of amounts depending on the desired system properties and end use applications. In latex paints, the composition is added such that the polymer or polymer compositions as described herein is present from about 0.05 to about 10 weight percent in one embodiment, in another embodiment from about 0.05 to about 5 weight percent, and in yet another embodiment from about 0.1 to about 3 weight percent based on total weight of the latex paint, including all of its components, such as water, one or more anti-settling additives as described herein, latex polymer, pigment, and any adjuvants.

In formulating latexes and latex paints/coating compositions, physical properties that may be considered include, but are not limited to, viscosity versus shear rate, ease of application to surface, spreadability, and shear thinning.

In some embodiments, the formulations and compositions described herein include surfactants such as anionic surfactants, cationic surfactants, non-ionic surfactants, zwitterionic surfactants, and mixtures thereof.

Suitable anionic surfactants are known compounds and include, for example, linear alkylbenzene sulfonates, alpha olefin sulfonates, paraffin sulfonates, alkyl ester sulfonates, alkyl sulfates, alkyl alkoxy sulfates, alkyl sulfonates, alkyl alkoxy carboxylates, alkyl alkoxylated sulfates, monoalkyl phosphates, dialkyl phosphates, sarcosinates, isethionates, and taurates, as well as mixtures thereof, such as for example, ammonium lauryl sulfate, ammonium laureth sulfate, triethanolamine laureth sulfate, monoethanolamine lauryl sulfate, monoethanolamine laureth sulfate, diethanolamine lauryl sulfate, diethanolamine laureth sulfate, lauric monoglyceride sodium sulfate, sodium lauryl sulfate, sodium laureth sulfate, potassium lauryl sulfate, potassium laureth sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, sodium monoalkyl phosphate, sodium dialkyl phosphate, sodium lauryl sarcosinate, lauroyl sarcosine, cocoyl sarcosinate, ammonium cocyl sulfate, sodium cocyl sulfate, potassium cocyl sulfate, monoethanolamine cocyl sulfate, sodium tridecyl benzene sulfonate, sodium dodecyl benzene sulfonate, and mixtures thereof.

The cationic counterion of the anionic surfactant is typically a sodium cation but may alternatively be a potassium, lithium, calcium, magnesium, ammonium cation, or an alkyl ammonium anion having up to 6 aliphatic carbon atoms, such as anisopropylammonium, monoethanolammonium, diethanolammonium, or triethanolammonium cation. Ammonium and ethanolammonium salts are generally more soluble than the sodium salts. Mixtures of the above cations may be used.

Suitable cationic surfactants are known compounds and include, for example, mono-cationic surfactants according to structure (XX) below:

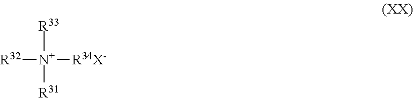

wherein:
R³¹, R³², R³³, and R³⁴, are independently hydrogen or an organic group, provided that at least one of R³¹, R³², R³³ and R³⁴ is not hydrogen, and
X⁻ is an anion,
   as well as mixtures of such compounds

If one to three of the R³¹, R³², R³³ and R³⁴ groups are each hydrogen, then the compound may be referred to as an amine salt. Some examples of cationic amine salts include polyethoxylated (2) oleyl/stearyl amine, ethoxylated tallow amine, cocoalkylamine, oleylamine, and tallow alkyl amine.

For quaternary ammonium compounds (generally referred to as quats) R³¹, R³², R³³ and R³⁴ may be the same or different organic group, but may not be hydrogen. In one embodiment, R³¹, R³², R³³ and R³⁴ are each C₃-C₂₄ branched or linear hydrocarbon groups which may comprise additional functionality such as, for example, fatty acids or derivatives thereof, including esters of fatty acids and fatty acids with alkoxylated groups; alkyl amido groups; aromatic rings; heterocyclic rings; phosphate groups; epoxy groups; and hydroxyl groups. The nitrogen atom may also be part of a heterocyclic or aromatic ring system, e.g., cetethyl morpholinium ethosulfate or steapyrium chloride.

Examples of quaternary ammonium compounds of the monoalkyl amine derivative type include: cetyl trimethyl ammonium bromide (also known as CETAB or cetrimonium bromide), cetyl trimethyl ammonium chloride (also known as cetrimonium chloride), myristyl trimethyl ammonium bromide (also known as myrtrimonium bromide or Quaternium-13), stearyl dimethyl benzyl ammonium chloride (also known as stearalkonium chloride), oleyl dimethyl benzyl ammonium chloride, (also known as olealkonium chloride), lauryl/myristryl trimethyl ammonium methosulfate (also known as cocotrimonium methosulfate), cetyl dimethyl (2)hydroxyethyl ammonium dihydrogen phosphate (also known as hydroxyethyl cetyldimonium phosphate), babassuamidopropalkonium chloride, cocotrimonium chloride, distearyldimonium chloride, wheat germ-amidopropalkonium chloride, stearyl octyldimonium methosulfate, isostearaminopropalkonium chloride, dihydroxypropyl PEG-5 linoleaminium chloride, PEG-2 stearmonium chloride, Quaternium 18, Quaternium 80, Quaternium 82, Quaternium 84, behentrimonium chloride, dicetyl dimonium chloride, behentrimonium methosulfate, tallow trimonium chloride and behenamidopropyl ethyl dimonium ethosulfate.

Quaternary ammonium compounds of the dialkyl amine derivative type include, for example, distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, hydroxypropyl bisstearyldimonium chloride, and mixtures thereof.

Quaternary ammonium compounds of the imidazoline derivative type include, for example, isostearyl benzylimidonium chloride, cocoyl benzyl hydroxyethyl imidazolinium chloride, cocoyl hydroxyethylimidazolinium PG-chloride phosphate, Quaternium 32, and stearyl hydroxyethylimidonium chloride, and mixtures thereof.

Typical cationic surfactants comprise dialkyl derivatives such as dicetyl dimonium chloride and distearyldimonium chloride; branched and/or unsaturated cationic surfactants such as isostearylaminopropalkonium chloride or olealkonium chloride; long chain cationic surfactants such as stearalkonium chloride and behentrimonium chloride; as well as mixtures thereof.

Suitable anionic counterions for the cationic surfactant include, for example, chloride, bromide, methosulfate, ethosulfate, lactate, saccharinate, acetate and phosphate anions.

Suitable nonionic surfactants are known compounds and include amine oxides, fatty alcohols, alkoxylated alcohols, fatty acids, fatty acid esters, and alkanolamides. Suitable amine oxides comprise, (C₁₀-C₂₄) saturated or unsaturated branched or straight chain alkyl dimethyl oxides or alkyl amidopropyl amine oxides, such as for example, lauramine oxide, cocamine oxide, stearamine oxide, stearamidopropylamine oxide, palmitamidopropylamine oxide, decylamine oxide as well as mixtures thereof. Suitable fatty alcohols include, for example, (C₁₀-C₂₄) saturated or unsaturated branched or straight chain alcohols, more typically (C₁₀-C₂₀) saturated or unsaturated branched or straight chain alcohols, such as for example, decyl alcohol, lauryl alcohol, myristyl alcohol, cetyl alcohol, stearyl alcohol, oleyl alcohol, linoleyl alcohol and linolenyl alcohol, and mixtures thereof. Suitable alkoxylated alcohols include alkoxylated, typically ethoxylated, derivatives of (C₁₀-C₂₄) saturated or unsaturated branched or straight chain alcohols, more typically (C₁₀-C₂₀) saturated or unsaturated branched or straight chain alcohols, which may include, on average, from 1 to 22 alkoxyl units per molecule of alkoxylated alcohol, such as, for example, ethoxylated lauryl alcohol having an average of 5 ethylene oxide units per molecule. Mixtures of these alkoxylated alcohols may be used. Suitable fatty acids include (C₁₀-C₂₄) saturated or unsaturated carboxylic acids, more typically (C₁₀-C₂₂) saturated or unsaturated carboxylic acids, such as, for example, lauric acid, oleic acid, stearic acid, myristic acid, cetearic acid, isostearic acid, linoleic acid, linolenic acid, ricinoleic acid, elaidic acid, arichidonic acid, myristoleic acid, and palmitoleic acid, as well as neutralized versions thereof. Suitable fatty acid esters include esters of (C₁₀-C₂₄) saturated or unsaturated carboxylic acids, more typically (C₁₀-C₂₂) saturated or unsaturated carboxylic acids, for example, propylene glycol isostearate, propylene glycol oleate, glyceryl isostearate, and glyceryl oleate, and mixtures thereof. Suitable alkanolamides include aliphatic acid alkanolamides, such as cocamide MEA (coco monoethanolamide) and cocamide MIPA (coco monoisopropanolamide), as well as alkoxylated alkanolamides, and mixtures thereof.

Suitable amphoteric surfactants are known compounds and include for example, derivatives of aliphatic secondary and tertiary amines in which the aliphatic radical can be straight chain or branched and wherein one of the aliphatic substituents contains from about 8 to about 18 carbon atoms and one contains an anionic water-solubilizing group as well as mixtures thereof. Specific examples of suitable amphoteric surfactants include the alkali metal, alkaline earth metal, ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates, such as for example, cocoamphoacetate cocoamphopropionate, cocoamphodiacetate, lauroamphoacetate, lauroamphodiacetate, lauroamphodipropionate, lauroamphodiacetate, cocoamphopropyl sulfonate caproamphodiacetate, caproamphoacetate, caproamphodipropionate, and stearoamphoacetate.

In one embodiment, the amphoteric surfactant comprises sodium lauroampoacetate, sodium lauroampopropionate, disodium lauroampodiacetate, sodium cocoamphoacetate, disodium cocoamphodiacetate or a mixture thereof.

Suitable Zwitterionic surfactants are known compounds. Any Zwitterionic surfactant that is acceptable for use in the intended end use application and is chemically stable at the required formulation pH is suitable as the optional Zwitterionic surfactant component of the composition of the present invention, including, for example, those which can be broadly described as derivatives of aliphatic quaternary ammonium, phosphonium, and sulfonium compounds in which the aliphatic radicals can be straight chain or branched and wherein one of the aliphatic substituents contains from about 8 to about 24 carbon atoms and one contains an anionic water-solubilizing group such as carboxyl, sulfonate, sulfate, phosphate or phosphonate. Specific examples of suitable Zwitterionic surfactants include alkyl betaines, such as cocodimethyl carboxymethyl betaine, lauryl dimethyl carboxymethyl betaine, lauryl dimethyl alpha-carboxy-ethyl betaine, cetyl dimethyl carboxymethyl betaine, lauryl bis-(2-hydroxy-ethyl)carboxy methyl betaine, stearyl bis-(2-hydroxy-propyl)carboxymethyl betaine, oleyl dimethyl gamma-carboxypropyl betaine, and lauryl bis-(2-hydroxypropyl)alpha-carboxyethyl betaine, amidopropyl betaines, and alkyl sultaines, such as cocodimethyl sulfopropyl betaine, stearyldimethyl sulfopropyl betaine, lauryl dimethyl sulfoethyl betaine, lauryl bis-(2-hydroxy-ethyl)sulfopropyl betaine and alkylamidopropylhydroxy sultaines.

In one embodiment, the personal care composition further comprises an electrolyte, typically in an amount of up to about 20 pbw per 100 pbw of the personal care composition. Suitable electrolytes are known compounds and include salts of multivalent anions, such as potassium pyrophosphate, potassium tripolyphosphate, and sodium or potassium citrate, salts of multivalent cations, including alkaline earth metal salts such as calcium chloride and calcium bromide, as well as zinc halides, barium chloride and calcium nitrate, salts of monovalent cations with monovalent anions, including alkali metal or ammonium halides, such as potassium chloride, sodium chloride, potassium iodide, sodium bromide, and ammonium bromide, alkali metal or ammonium nitrates, and polyelectrolytes, such as uncapped polyacrylates, polymaleates, or polycarboxylates, lignin sulfonates or naphthalene sulfonate formaldehyde copolymers.

As used herein in reference to viscosity, the terminology “shear-thinning” means that such viscosity decreases with an increase in shear rate. Shear-thinning may be characterized as a “non-Newtonian” behavior, in that it differs from that of a classical Newtonian fluid, for example, water, in which viscosity is not dependent on shear rate.

As used herein in reference to a component of an aqueous composition, the terminology “water insoluble or partially water soluble components” means that the component is present in the aqueous composition at a concentration above the solubility limit of the component so that, in the case of a water insoluble component, the component remains substantially non-dissolved in the aqueous composition and, in the case of a partially water soluble component, at least a portion of such component remains undissolved in the aqueous composition.

As used herein, characterization of an aqueous composition as “capable of suspending”, or as being “able of suspend” water insoluble or partially water insoluble components means that the composition substantially resists flotation of such components in the composition or sinking of such components in such composition so that such components appear to be neutrally buoyant in such composition and remain at least substantially suspended in such composition under the anticipated processing, storage, and use conditions for such aqueous composition.

In one embodiment, the personal care composition as described herein comprises, based on 100 pbw of the composition from about 5 to about 40 parts pbw, more typically from about 10 to about 30 pbw, and still more typically from about 15 to about 25 pbw, of the anionic surfactant and from about 0.1 to about 25 pbw, more typically, from about 0.5 to about 10 pbw, of a structuring agent.

In another embodiment, the polymers as described herein may also be polymerized or copolymerized with other monomers, including those disclosed above, to form yet different polymers and copolymers. The different polymers and copolymers can be obtained by polymerization or copolymerization in the manner described above.

In one embodiment, the emulsion polymerization technique comprises charging a kettle or reactor, and then heating the kettle or reactor while purging with nitrogen. The nitrogen purge is maintained throughout the run. A monomer emulsion (ME) of DI water (deionized water), surfactant, methyl acrylic acid, ethyl acrylate, and nopol-containing monomer according to structure (XXII) is added to the kettle, as well as an initiator solution (IS) of DI water and ammonium persulfate. The kettle is held for over approximately 3 hours at constant elevated temperature. The kettle is held for an additional 30 minutes while rinsing the additional funnel of IS and its tubing (disconnected from the batch) with water. (The tubing is then reconnected to the batch.) Part 1 of a chaser system/solution of tertbutyl peroxybenzoate is added to the kettle and IS additional funnel is filled with Part 2 of the chaser system/solution of isoascorbic acid and DI water. Part 2 is added over the course of 30 minutes. The kettle is held at constant elevated temperature for 30 minutes.

Structure (XXII), which is referred to as “NOPOL”:

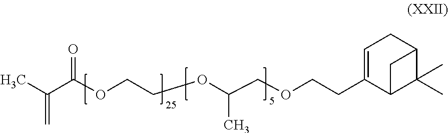

The Nopol monomer according to structure (XXII) can be made as follows Nopol alkoxylate (Nopol compound according to structure (XVI) above, alkoxylated with 5 moles propylene oxide and 25 moles ethylene oxide per mole, charged to a 500 ml round-bottom 5-neck glass flask equipped with a PTFE blade agitator, temperature sensor, dry compressed air purge line and a water cooled condenser. The liquid ethoxylate is warmed, stirred, and MEHQ is added. A purge of dry air at approximately 20 ml min−1 is passed through the liquid and later methacrylic anhydride is added. The temperature is stabilized and held between 70-74° C. for five and a half hours, then the liquid is cooled. Methacrylic acid and water are added and the liquid product is discharged.

### Experiments

Polymers were synthesized according to emulsion polymerization techniques as described herein and the results are summarized in Table 1 (The procedure in the foregoing paragraph was used to make R0837-23-01).

TABLE 1

| | Solids^{a} | Conv. | Particle | | Wet Coagulum |
|---|---|---|---|---|---|
| ID | (%) | (%) | size (nm) | PDI | (BOTL) |
| R0837-52-01 | 28.50 | 95.00 | 175.3 | 0.012 | 0.19 |
| Nopol-5PO-25EO | | | | | |
| R0837-148-01 | 28.25 | 94.16 | 149.5 | 0.013 | 0.11 |
| Nopol-5PO-25EO | | | | | |
| R0837-23-01 | 28.50 | 95.00 | 194.4 | 0.005 | 0.19 |
| Nopol-5PO-25EO | | | | | |

^{a}Solids content determined with moisture balance

Table 2 shows a representative example (R0837-127-01) having viscosity values (KU and ICI) of a stain (as described below) after addition of a representative polymer as claimed herein, which incorporates the monomer according to structure (XXII) (without chain transfer agent). A benchmark polymer (R0837-127-15) was used for comparison to show the effect on viscosity and stain viscosity is also showed as reference (R0837-127-10).

TABLE 2
Experiments carried out using polymer incorporating
the monomer according to structure (XXII).

| | Stain | | Polymer | | | time |
|---|---|---|---|---|---|---|
| Sample ID | (g) | Polymer ID | (g) | KU | pH | (h) |
| R0837-127- | 200 | — | — | 48.2 | 8.73 | 36 |
| 10 | | | | | | |
| R0837-127- | 200 | R0837-23- | 2.0 | 50.9 | 8.13 | 36 |
| 01 | | 01 | | | | |
| R0837-127- | 200 | TT935 | control | 64.3 | 8.13 | 36 |
| 15 | | | 2.0 | | | |

Sample ID R0837-127-10 is a commercially available wood stain, which has a low viscosity. The stain without polymer (Sample ID 80837-127-10) showed separation of pigments/fine particles from solution. The stain with polymer synthesized with the monomer according to structure (XXII) (Sample ID R0837-127-01) appeared to show a homogenous mixture and no separation to the naked eye during 36 hours. Moreover KU viscosity was not increased considerably. The stain with benchmark polymer (Sample ID R0837-127-15) appeared to show a homogenous mixture, no separation to the naked eye but KU viscosity was increased considerably (approximately by greater than 33%)

Formulations with Stain. Formulation with stain (28.35% solids) was carried out in a glass container according to the following representative procedure: to a solution of stain (200 g) at pH of 8.73 was added slowly the polymer (incorporating the monomer according to structure (XXII)). After being stirred in a roller mixer during 12 hours, the mixture was allowed to stand at least 5 minutes. Subsequently, KU, ICI and pH values were determined; procedure was repeated until phase separation was not observed. Stain used for these formulations: Commercial available Behr stain cedar tone.

Krebs stormer viscosimeter: Testing using the Krebs Stormer determines the load required to rotate an offset paddle immersed in the sample at 200 rpm. The Krebs Stormer is normally used for consistency measurement on paints and coating compositions. Results are reported in Krebs Units and the nature of the measurement does not allow conversion from Krebs units to any other more common viscosity unit such as centipoise. Test is done at or near room temperature. The design of the viscometer is based on the Standards ASTM D 562-81 and GB/T 9269-88.

The present invention has been described with particular reference to one or more embodiments. Accordingly, the present invention is not solely defined by the above description, but is to be accorded the full scope of the claims so as to embrace any and all equivalent compositions and methods.

What is claimed is:

1. An anti-settling additive comprising a polymer, the polymer comprising at least one monomer that comprises:
i) at least one polymerizable functional group per molecule; and
ii) at least one polyether radical per molecule according to structure (I):
—R¹³—R¹²—R¹¹ (I)
wherein:
R¹¹ is bicycloheptyl, bicycloheptenyl, or linear or branched (C₅-C₄₂) alkyl, wherein the bicycloheptyl- or bicycloheptenyl-polyether radical may optionally be substituted on one or more of the ring carbon atoms by one or two (C₁-C₆)alkyl groups per ring carbon atom,
R¹² is absent or is a bivalent linking group, and
R¹³ is according to structure (VIII):
OC_{p′}H_{2p′}ᵣOC_{q}H_{2q}ₛₜ (VIII)
wherein:
p′ and q are independently integers of from 2 to 5,
each r is independently an integer of from 1 to about 80,
each s is independently an integer of from 1 to about 80, and
t is an integer of from 1 to 50,
wherein the polymer is characterized by a weight average molecular weight of less than about 500,000 g/mol.

2. The additive of claim 1, wherein R¹¹ is derived from Nopol.

3. The additive of claim 1, wherein the polymerizable functional group is acrylo, methacrylo, acrylamido, methacrylamido, diallylamino, allyl ether, vinyl ether, α-alkenyl, maleimido, styrenyl, or α-alkyl styrenyl.

4. The additive according to claim 1, wherein the monomer comprises a compound according to structure (XI): 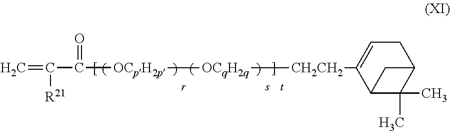
wherein
R²¹ is H or methyl,
p′ and q are independently integers of from 2 to 5,
each r is independently an integer of from 1 to about 80,
each s is independently an integer of from 1 to about 80, and
t is an integer of from 1 to 50, provided that the product of t multiplied times the sum of r+s is less than or equal to about 100.

5. The additive according to claim 1, wherein the monomer comprises a compound according to structure (XI.a): 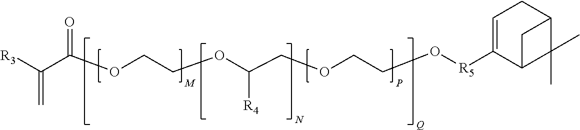
(XI.a)
wherein R₃ is H or CH₃; R₄ is an alkyl chain containing 1 to about 4 carbon atoms; R₅ is an alkyl chain containing 1 to about 6 carbon atoms; M is an integer from 0 to about 50; N is and integer from 1 to 20; P is an integer from 0 to about 50; wherein P+M is greater or equal to 1; wherein Q is an integer from 1 to 4.

6. The additive according to claim 1 wherein the anti-settling additive is utilized in a coating composition having a viscosity of less than about 200 KU.

7. The additive according to claim 1 wherein the polymer is characterized by a weight average molecular weight of less than about 250,000 g/mol and wherein the anti-settling additive is utilized in a coating composition having a viscosity of less than about 100 KU.

8. A method for inhibiting settling of particles in an aqueous composition, the method comprising the steps of:
(I) obtaining a polymer comprising, based on the total weight of monomers:
(a) from about 25 to about 70 percent by weight acid monomeric units, each independently comprising a carboxylic acid-functional substituent group,
(b) from about 30 to about 70 percent by weight nonionic monomeric units, each independently comprising a nonionic substituent group, and
(c) from about 0.05 to about 20 percent by weight monomeric units, each independently comprising at least one polyether radical according to structure (I):
—R¹³—R¹²—R¹¹ (I)
wherein:
R¹¹ is bicycloheptyl, bicycloheptenyl, or linear or branched (C₅-C₄₂) alkyl, wherein the bicycloheptyl- or bicycloheptenyl-polyether radical may optionally be substituted on one or more of the ring carbon atoms by one or two (C₁-C₆)alkyl groups per ring carbon atom,
R¹² is absent or is a bivalent linking group, and
R¹³ is according to structure (VIII):
OC_{p′}H_{2p′}ᵣOC_{q}H_{2q}ₛₜ (VIII)
wherein:
p′ and q are independently integers of from 2 to 5,
each r is independently an integer of from 1 to about 80,
each s is independently an integer of from 1 to about 80, and
t is an integer of from 1 to 50; and
(II) adding the polymer to the aqueous composition,
wherein the polymer has a weight average molecular weight of less than about 500,000 g/mol.

9. The method of claim 8 wherein the aqueous composition is a coating composition having a viscosity of less than about 200 KU.

10. The method of claim 8 wherein the aqueous composition is a coating composition having a viscosity of less than about 100 KU and wherein the polymer has a weight average molecular weight of less than about 250,000 g/mol.

11. A method of inhibiting settling of particles in an aqueous composition, said method comprising the steps of:
incorporating in said aqueous composition an anti-settling additive comprising a polymer having, based on the total weight of monomers,
(a) from about 25 to about 70 percent by weight acid monomeric units, each independently comprising a carboxylic acid-functional substituent group,
(b) from about 30 to about 70 percent by weight nonionic monomeric units, each independently comprising a nonionic substituent group, and
(c) from about 0.05 to about 25 percent by weight hydrophobic monomeric units, each independently comprising at least one polyether radical according to structure (I):
—R¹³—R¹²—R¹¹ (I)
wherein:
R¹¹ is bicycloheptyl, bicycloheptenyl, or linear or branched (C₅-C₄₂) alkyl, wherein the bicycloheptyl- or bicycloheptenyl-polyether radical may optionally be substituted on one or more of the ring carbon atoms by one or two (C₁-C₆)alkyl groups per ring carbon atom,
R¹² is absent or is a bivalent linking group, and
R¹³ is according to structure (VIII):
OC_{p′}H_{2p′}ᵣOC_{q}H_{2q}ₛₜ (VIII)
wherein:
p′ and q are independently integers of from 2 to 5,
each r is independently an integer of from 1 to about 80,
each s is independently an integer of from 1 to about 80, and
t is an integer of from 1 to 50;
wherein the polymer has a weight average molecular weight of less than about 500,000 g/mol.

12. The method of claim 11 wherein the aqueous composition is an aqueous paint composition comprising a resin binder, particles selected from the group consisting of pigments, fillers and reflecting agents, and water or a water-miscible solvent

13. The method of claim 11 wherein the anti-settling additive is added in an amount from about 0.5 wt % to about 1 wt % based on the total weight of the aqueous composition.

14. The method of claim 11 wherein the aqueous composition is a coating composition having a viscosity of less than about 200 KU.

15. The method of claim 11 wherein the aqueous composition is a coating composition having a viscosity of less than about 100 KU and wherein the polymer has a weight average molecular weight of less than about 250,000 g/mol.

16. A method for inhibiting settling of particles in an aqueous composition, the method comprising the steps of:
adding to an aqueous composition a polymer, the polymer comprising:
(a) about 25 to about 70 weight percent based on total monomers of at least one C₃-C₈ alpha beta-ethylenically unsaturated carboxylic acid monomer of the structure (II):
RCH═C(R′)COOH (II)
wherein R is H, CH₃, or —CH₂COOX; and wherein if R is H, then R′ is H, C₁-C₄ alkyl, or —CH₂COOX; if R is —C(O)OX, then R′ is H or —CH₂C(O)OX; or if R is CH₃, then R′ is H and X is H or C₁-C₄ alkyl;
(b) about 30 to about 70 weight percent based on total monomers of at least one copolymerizable non-ionic C₂-C₁₂ alpha beta-ethylenically unsaturated monomer of the structure (III):
CH₂═CYZ (III)
wherein Y is H, CH₃, or Cl; Z is CN, Cl, —COOR′, —C₆H₄R′, —COOR″, or —HC═CH₂; and wherein R is C₁-C₈ alkyl or C₂-C₈ hydroxy alkyl; and wherein R′ is H, Cl, Br, or C₁-C₄ alkyl; and R″ is C₁-C₈ alkyl; and
(c) about 0.05 to about 20 weight percent based on total monomer weight of at least one ethylenically unsaturated monomer represented by the structure selected from a group consisting of structure (IV) and structure (VI); wherein structure (IV) is 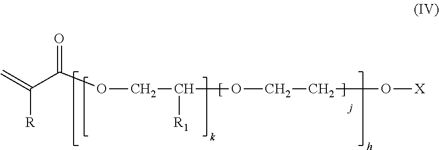
wherein R is H or CH₃; wherein R₁ is a —(CH₂)ₚH alkyl chain; wherein p is an integer from 1 to about 4; wherein j is an integer from 1 to about 50; wherein k is an integer from 0 to about 20, wherein h is 1 or 2; and wherein X has the following structure (V): 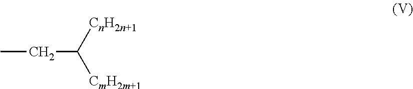
wherein m and n are, independently, are positive integers from 1 to 39 and m+n represents an integer from 4 to 40; and wherein structure (VI) is 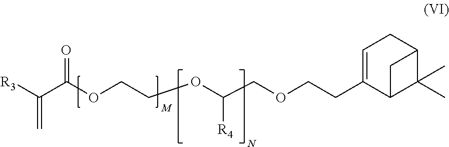
wherein R₃ is H or CH₃; R₄ is an alkyl chain containing 1 to about 4 carbons; M is an integer from 1 to about 50; and N is 1 or an integer less than or equal to M.

17. The method of claim 16, wherein the carboxylic acid monomer a) is selected from a group consisting of methacrylic acid, acrylic acid and a combination thereof.

18. The composition of claim 16, wherein b) is ethyl acrylate.

19. A method of inhibiting settling of particles in an aqueous composition, said method comprising the steps of:
incorporating in said aqueous composition an anti-settling additive comprising a polymer comprising, based on the total weight of monomers,
(a) from about 25 to about 70 percent by weight acid monomeric units, each independently comprising a carboxylic acid-functional substituent group,
(b) from about 30 to about 70 percent by weight nonionic monomeric units, each independently comprising a nonionic substituent group, and
(c) from about 0.05 to about 25 percent by weight monomeric units according to structure (XI.a): 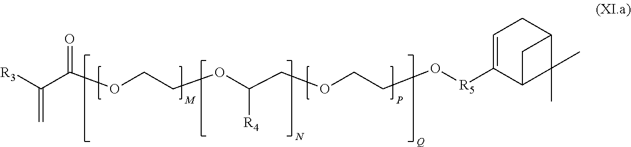
wherein R₃ is H or CH₃; R₄ is an alkyl chain containing 1 to about 4 carbon atoms; R₅ is an alkyl chain containing 1 to about 6 carbon atoms; M is an integer from 0 to about 50; N is and integer from 0 to 20, or an integer of less than or equal to M or N; P is an integer from 0 to about 50; wherein P+M is greater or equal to 1; wherein Q is an integer from 1 to 4;
wherein the polymer has a weight average molecular weight of less than about 500,000 g/mol.

20. The method of claim 19 wherein the aqueous composition is a coating composition having a viscosity of less than about 200 KU.

21. The method of claim 19 wherein the aqueous composition is a coating composition having a viscosity of less than about 100 KU and wherein the polymer has a weight average molecular weight of less than about 250,000 g/mol.

22. An aqueous coating composition having anti-settling properties, the composition comprising:
(a) at least one resin binder;
(b) optionally, at least one pigment
(b) an anti-settling additive comprising a polymer,
wherein the polymer comprises, based on the total weight of monomers:
(i) from about 25 to about 70 percent by weight acid monomeric units, each independently comprising a carboxylic acid-functional substituent group,
(ii) from about 30 to about 70 percent by weight nonionic monomeric units, each independently comprising a nonionic substituent group, and
(iii) from about 0.05 to about 25 percent by weight hydrophobic monomeric units, each independently comprising at least one polyether radical according to structure (I):
—R¹³—R¹²—R¹¹ (I)
wherein:
R¹¹ is bicycloheptyl, bicycloheptenyl, or linear or branched (C₅-C₄₂) alkyl, wherein the bicycloheptyl- or bicycloheptenyl-polyether radical may optionally be substituted on one or more of the ring carbon atoms by one or two (C₁-C₆)alkyl groups per ring carbon atom,
R¹² is absent or is a bivalent linking group, and
R¹³ is according to structure (VIII):
OC_{p′}H_{2p′}ᵣOC_{q}H_{2q}ₛₜ (VIII)
wherein:
p′ and q are independently integers of from 2 to 5,
each r is independently an integer of from 1 to about 80,
each s is independently an integer of from 1 to about 80, and
t is an integer of from 1 to 50;
wherein the polymer has a weight average molecular weight of less than about 500,000 g/mol.

23. The aqueous coating composition of claim 22 wherein the aqueous coating composition a viscosity of less than about 200 KU.

24. The aqueous coating composition of claim 22 wherein the polymer is characterized by a weight average molecular weight of less than about 250,000 g/mol and wherein the aqueous coating composition has a viscosity of less than about 100 KU.
